(19) United States
(12) Patent Application Publication
(10) Pub. No.: US 2026/0196146 A1
(43) Pub. Date: Jul. 9, 2026

(54) MOTION SIMULATOR

(71) Applicant: Dalecarlia Dynamics AB, Mora (SE)

(72) Inventors: Andreas FRÖDERBERG, Mora (SE); Henrik HVITFELDT, Torslanda (SE)

(73) Assignee: Dalecarlia Dynamics AB, Mora (SE)

(21) Appl. No.: 19/132,213

(22) PCT Filed: Nov. 30, 2023
(86) PCT No.: PCT/SE2023/051208

§ 371 Date: May 22, 2025

(30) Foreign Application Priority Data
Dec. 1, 2022 (SE) 2251402-0

(51) Int. Cl. G09B 9/042

(52) U.S. Cl. CPC G09B 9/042

(57) ABSTRACT

The invention relates to a motion simulator comprising a base; a movable platform being movable in relation to the base, having a seat and driver manoeuvrable means for, in use, receiving driving commands from a user situated in the seat, the driving commands being configured to, in use, control motion of a vehicle; at least one first motion applying means comprising at least one motion actuator connecting the movable platform to the base, the at least one first motion applying means being configured to generate a displacement of the movable platform in relation to the base; a support mechanism comprising an upper suspension configured to suspend the movable platform from above; at least one second motion applying means comprising at least one motion actuator connecting the upper suspension to the support mechanism, the at least one second motion applying means being configured to generate a displacement of the movable platform in relation to the base.

### FIELD OF THE INVENTION

The invention relates generally to motion simulators. In particular, the present invention relates to a motion simulator comprising a movable platform for simulating motions of a simulated vehicle.

### BACKGROUND OF THE INVENTION

There exist various kinds of motion simulators, such as motion simulators for simulating driving of a motor vehicle. Such motion simulators may comprise a movable platform which is mobile with respect to a support plane, and where a driver seat and driver manoeuvrable means, such as a steering wheel, accelerator, brake pedal are provided on the movable platform. The motion simulator may then receive driving commands from a user situated in the driver seat, and apply an appropriate displacement of the movable platform in response to the received driving commands to thereby increase the impression of actual driving of a vehicle.

A plurality of motion actuators may be arranged between the movable platform and the support plane, where the motion actuators may be configured to provide a displacement of the movable platform to simulate the motions that occur during driving of an actual vehicle, such as acceleration, deceleration, and/or turning motions.

Motion actuators may be utilised for various purposes. Low-cost motion simulators may be utilised, e.g., for playing games to give a better user experience. More sophisticated motion simulators may also be used to assist, e.g., in remote driving of vehicles where the motion simulator provides the remote driver with an accurate feedback of the driven vehicle's actual manoeuvres so as to be able to take appropriate actions in a manner similar to actually being present in the vehicle. Various sensors provided on, or already present in, the remote driven vehicle may be utilised to transfer motion control signals to the motion simulator.

Motion simulators may also be used, e.g., for testing vehicles in vehicle design, e.g. by vehicle manufacturers, where behaviour and vehicle functionality may be evaluated through simulation even before a vehicle, or a vehicle function such as driving aid functionality is actually built/implemented based on one or more vehicle models so that a great deal of testing may be carried out even before a prototype is built. Motion simulators may also be utilised for practicing driving skills, e.g. in motor racing or for evaluation purposes.

### SUMMARY OF THE INVENTION

It is an object of the present invention to provide a motion simulator that provides for an accurate user experience where the user is subjected to accelerations that behave similar to accelerations experienced during real-life driving of an actual vehicle on a road.

According to a first aspect of the invention it is provided a motion simulator, comprising:
a base;
a movable platform being movable in relation to the base, having a seat and driver manoeuvrable means for, in use, receiving driving commands from a user situated in the seat, the driving commands being configured to, in use, control motion of a, e.g., simulated, vehicle;
at least one first motion applying means comprising at least one motion actuator connecting the movable platform to the base, the at least one first motion applying means being configured to generate a displacement of the movable platform in relation to the base;
a support mechanism comprising an upper suspension configured to suspend the movable platform from above;
at least one second motion applying means comprising at least one motion actuator connecting the upper suspension to the support mechanism, the at least one second motion applying means being configured to generate a displacement of the movable platform in relation to the base.

With regard to motion simulators, such as motion simulators for simulating driving of a motor vehicle (e.g., a car, motorcycle, truck, bus), but also with regard to simulation of other types of vehicles such as aircrafts or watercrafts, it is desirable to obtain a displacement of a movable platform of the motion simulator, and hence also of the driver/user of the simulated vehicle, that corresponds to a motion that the actual vehicle would exhibit when subjected to the same driver commands, e.g. in terms of acceleration, deceleration, etc.

Given the general physical limitations of a motion simulator it is difficult, or not even possible, to precisely mimic the movements that an actual vehicle would undergo when subjected to particular driver commands. For example, acceleration and deceleration, in particular prolonged such events, may be difficult to replicate, and motion simulators therefore oftentimes provide a motion response of lesser magnitude and/or extension in time in comparison to the real-life event. Still, this may provide a highly satisfactory user experience in terms of the actual perception of the virtual driving experience.

A drawback of, in particular, motion simulators that are intended for use in non-designated spaces, i.e. non-industrial motion simulators, is that particular motions that the simulated vehicle actually undergo may be simulated by a motion that, although giving rise to an acceleration of the movable platform that at first glance may resemble the behaviour of the real-life vehicle, may give rise to an acceleration that in fact is opposite to, or at least very different to, the acceleration that the human brain would expect during real-life driving. This, in turn, may give rise to adverse side effects such as motion sickness and/or blurry vision, with the result that a user of the motion simulator may have to abort from further use, or spend a substantial period of time of training in order to accommodate the brain to non-natural motions of the movable platform, hence making the technology hard to grasp and less usable for training.

There exist solutions where this is accounted for. For example, this may be accounted for by the, in general very large, industrial motion simulators. Motion simulators of this kind, however, require a large and purpose built space for permanent usage, often involving or including a control room, which is not only extremely costly, but also not possible to use as a solution when space is limited. Such motions simulators are primarily for use in research and development. There also exist “semi-professional” motion simulators using a hexapod solution for attaching the movable platform to the base. Solutions of this kind are capable of generating motions that correspond to actual accelerations that a user is subjected to during simulated driving. However, such simulators are still costly and in general unavailable for broader use.

With regard to relatively simpler solutions, and thereby more accessible for general use, problems of the above kind oftentimes occur.

According to aspects of the invention, it is provided a motion simulator that is capable of providing motions that give rise to accelerations of the user in expected directions when simulating driving of the vehicle so that problems of feeling ill or motion sickness when using the motion simulator can be mitigated or even avoided.

According to a first aspect of the invention, this is provided by a motion simulator where, similar to various other designs, a movable platform is movable in relation to a base, where at least one first motion applying means comprising at least one motion actuator connect the movable platform to the base, so that a displacement of the movable platform can be generated in relation to the base through control of the at least one motion actuator. The motion of the at least one motion actuator may be calculated on the basis of driver commands, where the movable platform comprises driver manoeuvrable means for, in use, receiving driving commands from a user when situated in a seat of the movable platform. The driver commands are used to control motion of a simulated vehicle, and hence of the movable platform by emulating the motions that the simulated vehicle would undergo during real-life driving.

In addition to the at least one first motion applying means connecting the movable platform to the base, the motion simulator comprises a support mechanism comprising an upper suspension configured to suspend the movable platform from above. Hence, in addition to the movable platform being attached to the base from below, the movable platform is also suspended from above. Furthermore, at least one second motion applying means comprising at least one motion actuator connect the upper suspension to the support mechanism in order to generate a displacement of the upper suspension and thereby movable platform in relation to the base, where the upper suspension is also displaced in relation to the support mechanism through the at least one second motion applying means.

The base may constitute a part or parts providing support of the motion simulator, such as a bottom plate, and/or a further, or other, bottom structure being located below the movable platform. The base may be configured to carry and/or support the movable platform, and/or structural parts that carry the movable platform, such as the support mechanism comprising second motion applying means and upper suspension. A surface upon which the motion simulator is resting may also form part of the base, e.g., by elements of the motion simulator being attached to this surface.

Hence, according to the first aspect of the invention, the motion simulator is configured to cause a motion of the movable platform utilising at least one motion actuator that act on the movable platform from above and also at least one motion actuator that act on the movable platform from below through the first motion applying means attaching the movable platform to the base. This provides for the possibility of achieving motions of the movable platform that to a high extent correspond to motions that would be experienced during real-life driving, and also accelerations that correspond to the accelerations that the body of the user of the motion simulator would experience during real-life driving. This provides for a solution where the risk of the user feeling ill during simulated driving may be substantially reduced, in particular when compared to existing low cost, or cost efficient, motion simulator solutions.

Preferably, the at least one first motion applying means is attached to the base at a position below the movable platform, so as to connect the movable platform to a position of the motion actuator being located below the movable platform. This may apply to some or each of the one or more motion actuators of the first motion applying means.

According to embodiments of the invention, the at least one first motion applying means and the at least second motion applying means are configured to be simultaneously controlled to displace the movable platform in response to received driving commands. The interaction of simultaneous movement of the first motion applying means and the second motion applying means allow for further possibilities regarding the displacing motions of the movable platform.

According to embodiments of the invention, the at least one first motion applying means and the at least second motion applying means are configured such that simultaneous activation allow translational motion of the movable platform in at least one non-vertical direction. Hence, both rotational and translational motion of the movable platform are made possible according to embodiments of the invention.

According to embodiments of the invention, the at least one first motion applying means comprises at least three motion actuators, each motion actuator attaching the movable platform to different locations of the base, and being configured to displace the movable platform in relation to the base. This provides for the possibility of achieving, e.g., turning left/right and motions, as well as further motions such as tilting the movable platform, in particular in combination with simultaneous control of the upper motion applying means.

According to embodiments of the invention, at least two, or all, of the motion actuators of the first motion applying means are attached to the base at a position below the movable platform. The motion simulators may thereby be of a design where motion actuators connect to the movable platform from below as in conventional motion simulators, but where in addition the at least one motion actuator of the second (upper) motion applying means also connect to the movable platform from above.

According to embodiments of the invention the motion actuators are attached to different positions on the movable platform, and different positions on the base. This further increases the possible motions of the movable platform.

According to embodiments of the invention, the at least one first motion applying means comprises three motion actuators being arranged in a tripod configuration, i.e., the three motion actuators are attached to different positions on the base of the motion simulator. This provides for a high degree of freedom regarding the possible motions of the movable platform that can be obtained.

According to embodiments of the invention, the at least one second motion applying means comprises at least two motion actuators, the motion actuators being configured to generate a displacement of the upper suspension in different directions. This provides for a motion simulator where, e.g., translational displacement of the movable platform may be obtained in more than one direction, such as in a forward/backward (longitudinal) direction and a left/right (transversal) direction in relation to a general driving direction of a simulated vehicle. This also allows that lateral acceleration as well as longitudinal acceleration may be simulated in a manner providing accelerations that act on the user in the same direction as during driving of an actual vehicle.

According to embodiments of the invention, the movable platform has a longitudinal direction, representing a general longitudinal direction of a simulated vehicle, and a lateral direction, wherein the at least one second motion applying means is configured to generate a displacement of the upper suspension in at least one of: a longitudinal direction, a transversal direction, a vertical direction, in relation to the base.

The at least one first motion applying means and the at least one second motion applying means may be configured to, through motion of one or more motion actuators of the first and second motion applying means, displace the movable platform in relation to the base such that the movable platform:
is subjected to an acceleration constituting one of, or a combination of, a rotation about a vertical axis, a rotation about an axis parallel to a longitudinal axis, a rotation about an axis parallel to a transversal axis, a translational motion along the longitudinal axis, a translational motion along the transversal axis, a translational motion along the vertical axis. According to embodiments of the invention it is hence provided for various different motions of the movable platform in relation to the base to provide for a good user experience in the simulated driving.

According to embodiments of the invention, the motion actuators of the at least one first motion applying means and the at least one second motion applying means are configured to displace the movable platform in relation to the base by means of a linear motion along the base where, e.g., a linear element attached to the movable platform by one end is displaced at its other end along the base.

For example, one or more of the motion actuators may comprise a track rigidly attached to the base or upper support, the track, e.g., running in a horizontal direction, and an elongated member, a first end of which being displaceable along the track, and the second end of the elongated member being attached to the movable platform and/or upper suspension, the motion actuator being configured to displace the movable platform by means of a displacement along the track.

Alternatively, or in addition, motion to displace the movable platform is accomplished by a linear extension/retraction of a linear element, such as a cylinder provided with a piston, of one or more motion actuators attaching the movable platform to the base. Different types of actuators may be combined.

According to embodiments of the invention, one or more of the motion actuators, e.g., the linear elements, may be attached to the movable platform by means of a first articulated joint, and to the base by means of a second articulated joint. This allows further flexibility in the possible motions of the movable platform. Such articulated joints may, e.g., comprise one or more form a spherical joint, a universal joint.

According to embodiments of the invention, the motion simulator further comprises computer-implemented control means configured to receive signals representing driving commands received by the driver manoeuvrable means, and compute a motion of the movable platform in response to the received driving commands, where actuator control signals are computed based on the computed motion of the movable platform, and where the actuator control signals are provided to the one or more motion actuators of the at least one first motion applying means and/or the at least one second motion applying means to effectuate the computed motion of the movable platform.

Hence, the computational power may form part of the motion simulator, where the calculations may be carried out based on a vehicle model of the vehicle being simulated. According to embodiments of the invention, the motion simulator is instead configured to be connected to an external computer that carries out the computations based on received signals from the driver manoeuvrable means and provides the motion actuators with control signals for carrying out the calculated motions.

According to embodiments of the invention, the driver manoeuvrable means are configured to receive driving commands constituting one or more from: steering commands, brake commands, acceleration commands.

The driver manoeuvrable means may comprise one or more from a steering wheel or other steering mechanism, accelerator means such as an accelerator pedal, brake means such as a brake pedal.

According to embodiments of the invention, the support mechanism is attached to, or form part of, the base.

According to embodiments of the invention, the support mechanism is configured such that the upper suspension suspends the movable platform at a point of rotation being located at a first height above the seat so as to be located at least a predetermined distance above a head of a user when situated in the seat. This provides for a solution where the obtaining of accelerations acting on the user that go in the right direction is facilitated by fully or partly causing an acceleration by rotation about the point of rotation.

According to embodiments of the invention the motion actuators may be hydraulically and/or electromechanically actuated motion actuators.

Further advantageous embodiments of the motion simulator according to the present invention and further advantages with the embodiments of the present invention emerge from the detailed description of embodiments.

### BRIEF DESCRIPTION OF THE DRAWINGS

FIG. 1 illustrates a first exemplary embodiment of a motion simulator according to embodiments of the invention;

FIGS. 2A-B illustrates forces that a vehicle and driver undergo when turning left;

FIG. 3 illustrates forces that act on a user of a prior art motion actuator when simulating turning left;

FIG. 4 illustrates a motion that the motion actuator of FIG. 1 undergoes when simulating turning left;

FIG. 5 illustrates forces that act on a user of the motion actuator according to FIG. 1 when simulating turning left;

FIG. 6 illustrates an exemplary position of the movable platform following a translational displacement to the right in the general direction of driving;

FIG. 7 illustrates upper motion applying means comprising two motion actuators;

FIG. 8 illustrates a further example of motion actuators.

### DETAILED DESCRIPTION OF EXEMPLARY EMBODIMENTS

Embodiments of the present invention will be exemplified in the following.

As was mentioned above, motion simulators may be utilised in various situations. The general object of a motion simulator is to simulate the movements that a vehicle undergo during driving on a road or similar, where these motions are mapped to the motion simulator, which then carries out motions that correspond to the actual motions that the simulated vehicle undergo when in motion. Obviously, while an actual vehicle may move essentially freely in space, a motion simulator is subjected to space limitations and the motion actuators providing displacement of the movable platform also have limited stroke length.

The real-life movements are therefore transformed to motions that the motion simulator is capable to carry out. Still, the motions that the movable platform undergo may provide the user with valuable information regarding the manner in which the real-life vehicle behaves, or would behave, and may in view of this take appropriate actions when manoeuvring the simulated vehicle.

A vehicle model of the vehicle to be simulated may be utilised to calculate control signals for controlling motion of motion actuators of the motion simulator based on the commands received by the driver manoeuvrable means of the movable platform. With regard to remote driving various sensors may be provided on, or already be present in, the remote driven vehicle and be utilised to calculate motion control signals to the motion simulator so as to facilitate remote driving.

As was also briefly discussed above, there are drawbacks in some conventional designs of motion simulators. Such drawbacks are at least mitigated by a motion simulator according to embodiments of the invention.

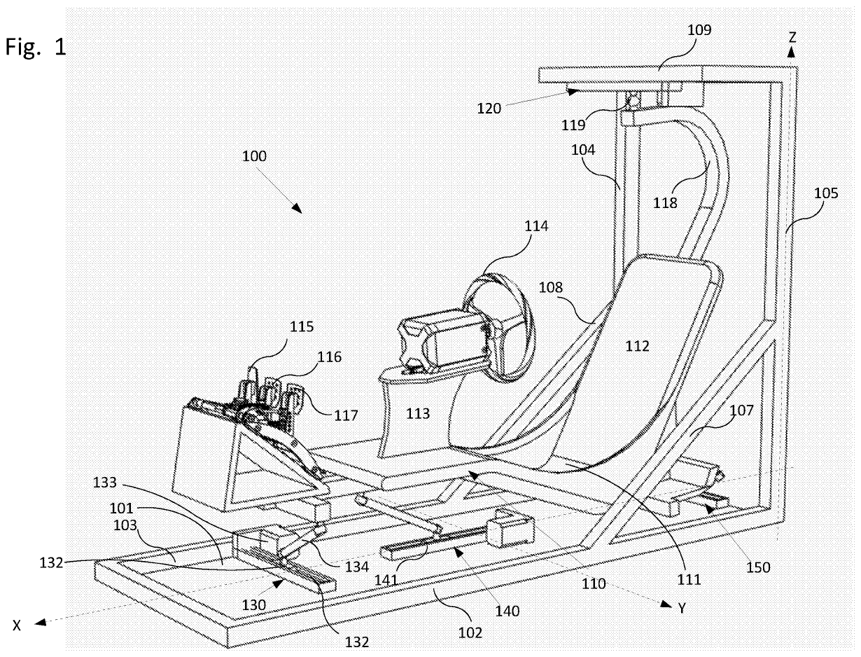

FIG. 1 illustrates a first example of a motion simulator 100 according to embodiments of the invention, which is suitable for use, e.g., when playing video games, simulating racing vehicles and performing remote driving of vehicles, but which may also be used for other purposes.

The motion simulator 100 comprises a bottom plate 101 which carries the parts that make up the motion simulator 100, and which forms part of a base and also forms part of a frame. According to the present example, the frame consists of hollow structural sections in the form of square tubes being joined together, or forming a single integrated element, or plural integrated elements joined together. It is to be understood that various other designs of the frame may be used instead of the one being illustrated in the figure. Also, the motion simulator may be of a design without a bottom plate. With further reference to the frame, two horizontal longitudinal bottom frame members 102, 103 are attached to the bottom plate 101, and also form part of the base according to the present example. In case, for example, no bottom plate is present, such frame members, or similar means, may make up the base of the motion simulator and carry and/or support the parts carrying the movable platform, and may also support motion actuators. Furthermore, a front bottom frame member 104 connects the longitudinal frame members 102, 103. The frame further comprises vertical frame members 105, 106 attached to the longitudinal beams at the ends being opposite to the ends facing the front bottom frame member. The frame also comprises support members 107, 108 interconnecting the vertical frame members and the horizontal longitudinal frame members at an angle to increase structural rigidity.

The frame further comprises a top portion 109 attached to, or forming an integrated part with, the upper end of the vertical frame members 105, 106.

According to embodiments of the invention, any or all of the frame members may together form one or more integrated parts, such as all frame members forming an integrated part.

According to the present example, the bottom plate 101 forms a base of the motion simulator. The longitudinal frame members 102, 103 may also form part of the base. The motion simulator 100 further comprises a movable platform 110, which may be of various different designs, and according to the present example being formed as a support structure having an integrated seat 111 with a back rest 112 for use by a user when using the motion simulator 100. It is to be understood that the movable platform, as well as the frame, may be of essentially any suitable design, hence the illustrated design is only exemplary.

The movable platform 110 further comprises a support 113 carrying a driver manoeuvrable means in the form of a steering wheel 114 configured to allow a user of the motion simulator to provide steering commands for steering a simulated vehicle. The movable platform 110 furthermore comprises and supports additional driver manoeuvrable means in the form of an accelerator 115, a brake pedal 116 and a clutch pedal 117 for allowing further control on a simulated vehicle. It is to be understood that the movable platform may comprise additional, other and/or less driver manoeuvrable means than the ones illustrated in the figure.

The movable platform is attached to the top portion 109 of the frame through a suspension member 118 which is fastened to the top portion 109 through an articulated joint 119, such as a spherical joint, a universal joint or any other suitable connection means allowing for the desired motion on the movable platform in relation to the frame. The articulated joint 119 is attached to, or forms part of, an upper motion applying means comprising at least one motion actuator 120. The vertical forces acting on the movable platform 110 are carried, at least to a large extent, by the top portion 109 through the suspension member 118, articulated joint 119 and motion actuator 120. The motion actuator 120 is designed to, according to the present example, subject the suspension member 118, and thereby movable platform 110 to a transversal motion in relation to the frame.

It is to be understood that various kinds of motions may be carried out using a motion simulator, and in general a coordinate system is utilised to define the various motions.

According to the present example the following definitions are used:
X=represents a longitudinal displacement, being defined as positive in the general forward direction of motion of the simulate vehicle;
Y=represents a lateral displacement, being defined as positive for a displacement to the left in relation to the general forward direction of motion of the vehicle;
Z=represents a vertical displacement, being defined as positive upwards in relation to the direction of driving;
There may also be rotation about the various axis, where, roll=rotation about the X axis, pitch=rotation about the Y axis, being and yaw=rotation about the Z axis.

It is to be understood that different coordinate systems may be utilised for different types and/or brands of motion simulators, hence the above example is only exemplary.

The motion actuator 120 hence provides a displacement along the Y axis in the figure.

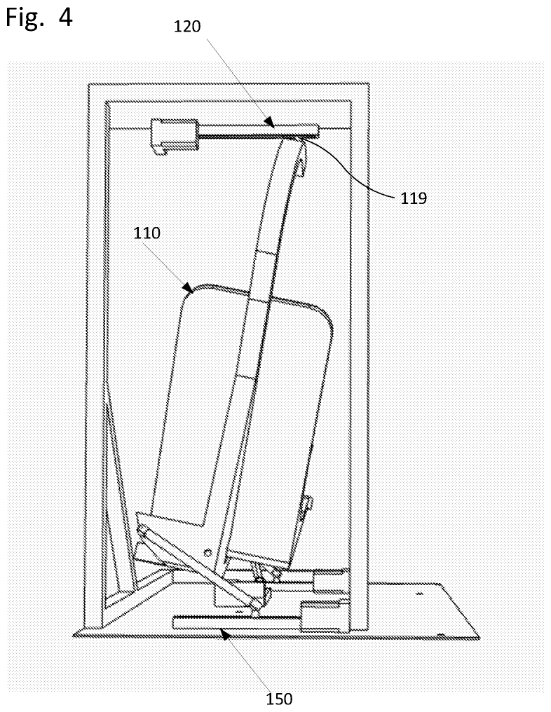

Furthermore, the motion simulator 110 also comprises lower motion applying means comprising, according to the illustrated example, three additional motion actuators 130, 140, 150. A front motion actuator 130 comprises a track 131 being arranged in the general transversal direction Y and in which a motion member 132 is configured to run back and forth under the control of an actuator motor 133 controlling the motion of the motion member 132. A rod 134 connects the movable platform 110 to the motion member 132, e.g. through suitable articulated joints, and the motion actuator 130 is configured to set the movable platform 110 in motion through appropriate displacement of the motion member 132 along the track 131. A second motion actuator 140 is provided towards the middle of the bottom plate, and having the same operating principle as the motion actuator 130, with the difference that the track 141 instead run along the general longitudinal direction X of the motion simulator. Finally, a third motion actuator 150 (being more visible in FIG. 4) being of a similar type as the motion actuators 130, 140 and being arranged at the back of the motion simulator 110 and operating in the same manner, i.e. connecting the movable platform 110 to a movable member that runs along a track through a rod. The third motion actuator 150, similarly to the motion actuator 130, has a track that runs in the general transversal direction Y of the motion simulator.

It is to be understood that the particular arrangement of the motion actuators of the present example is only exemplary, and the motion actuators may be arranged in various different positions on the bottom plate in relation to the movable platform 110 and may also be provided with tracks that run in other directions that the directions X and Y as illustrated in the figure. The motion actuators may also be attached to other positions on the movable platform. The motion actuators may also be of different designs, which is exemplified below with reference to FIG. 8. The motion actuators may be hydraulically and/or electromechanically actuated motion actuators.

The upper motion actuator 120, together with the motion actuators 130, 140, 150, provide for various possibilities with regard to possible motions of the movable platform 110 in relation to the frame, and in particular provides for motions that accurately mimic motions that a vehicle undergo during real-life driving.

The motion simulator of FIG. 1 may be utilised to carry out motion of the movable platform that provides accelerations acting on the user that corresponds, at least in direction, to accelerations being experienced during real-life driving of a vehicle.

As was mentioned, it is desired that the motion simulator accurately replicates the behaviour of the simulated vehicle, given the physical constraints of the motion simulator to a lesser or greater extent.

In general, the motion simulator is controlled by a motion cueing algorithm that controls the manner in which the motion simulator is to move in response to movements of the simulated vehicle, where the algorithm converts the vehicle motions to admissible movements that the motion actuators of the motion simulator are capable to provide. The amplitude and length of the motions, however, are in general limited. For example, if the vehicle simulated undergoes a roll of, e.g. 1°, the motion simulator may replicate this motion by a roll in the same direction, but to a lesser extent, e.g. 0.5° or any other suitably scaled motion.

Also, initial acceleration of a motion that a vehicle being simulated undergoes may be replicated to a high extent by a motion simulator. However, since the motion actuators have limited stroke lengths, the extent of the simulated motion will be restricted, or reduced, in time, since the movement must take into account the movement end positions of the actuators, and preferably stop before these limits are reached. Also, the motion actuators need to “reset” in preparation of a subsequent motion. The motions are accounted for by the software controlling the motion actuators, and various techniques exist for this, such as “tilt coordination” and “wash out/centring”. These techniques are known to the person skilled in the art and not described herein.

The motion cueing, however, is not always of a kind where the accelerations acting on the user are directed in the right direction, even though this at first glance may appear to be the case. In order to carry out accurate motion cuing it is necessary to understand the manner in which the vehicle behaves in various situations. For example, when driving through a curve, this can be seen as if the vehicle is driving along the periphery of a circle, where the turn is caused by the vehicle tires generating a lateral force directed inwards towards the centre of rotation of the curve/circle. This force, in turn, causes the vehicle to tilt outwards, caused by the change in load from the inside wheels to the outside wheels which in turn compresses the outside wheel suspension, but where the lateral acceleration that the vehicle, and thereby driver, actually is subjected to is in fact directed inwards towards the centre of the circle. There is hence not a centrifugal force acting on the vehicle that causes it to tilt.

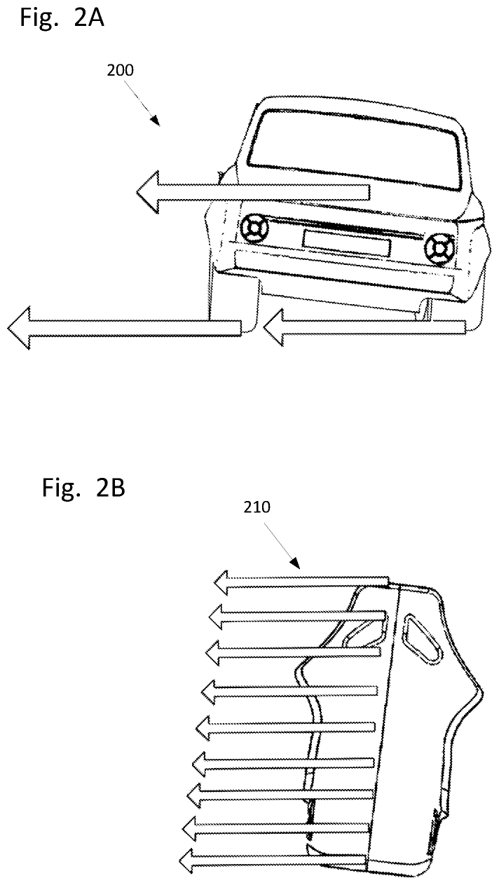

This is illustrated in FIGS. 2A-2B, where FIG. 2A exemplifies a vehicle 200 taking a curve to the left when driving on a road and the forces acting on it is illustrated by arrows directed inwards towards the rotation centre of the curve, and where also forces acting on the wheels, and pulling inwards, are illustrated. FIG. 2B illustrates the corresponding forces that the driver's seat, and thereby driver, is subjected to. That is, forces directed inwards and not outwards.

Similarly, when a vehicle is braking, this causes the vehicle to tilt forwards, caused by the change in load from the rear wheels to the front wheels which in turn compresses the front wheel suspension. In this case, too, the acceleration that the vehicle, and driver, actually undergoes is directed backwards. Correspondingly this also applies to acceleration, where instead, although the body of the driver appears to be pushed backwards relative to the vehicle, it still undergoes an acceleration in the direction of motion of the vehicle.

In order to avoid e.g. motion sickness during use of a motion simulator it is important that the human body perceives the motion in a similar way as the motions are perceived in a vehicle. The human body is sensitive to acceleration through various body motion sensors. Visual and haptic feedback is provided through the eyes, hands, feet, interaction with the seat etc. Furthermore, the body motion sensors include the inner-ear sensors, e.g. the vestibular sensors comprising semi-circular canals and otoliths. These body motion sensors are in particular sensitive to translational acceleration (otoliths) and rotational acceleration (semi-circular canals).

During real-life driving the brain is subconsciously expecting to receive the motion cues before registering the associated and expected change through visual cues because the impulses from the body motion sensors are processed faster by the brain in comparison to visual cues. In motion simulators the brain may be subjected to a false cue such as an acceleration that goes in an opposite direction in relation to the acceleration that the acceleration that the simulated actual vehicle would undergo. For example, the motion simulator may “tell” the brain through the motions that the vehicle is turning e.g. right, but where the visual feedback of the simulator may instead indicate to the brain that the vehicle is turning left. Similarly, the body motion sensors may register an acceleration of the simulated vehicle, while instead the visual cues visualise a braking of the vehicle instead.

If the motion cues of a motion simulator do not back up visual cues, the brain may, as mentioned, become disoriented and as a result the user of the simulator may be subject to, e.g., motion sickness and/or blurry vision, due to the mismatch in visual cues in relation to the cues expected by the brain.

The present invention provides a cost-efficient solution that alleviates problems with false cues while simultaneously provides for a high degree of freedom in terms of possible motions of the movable platform through the use of upper and lower motion applying means. This is accomplished by utilising a point of rotation above the head of a user instead of utilising a point of rotation at a point below the user.

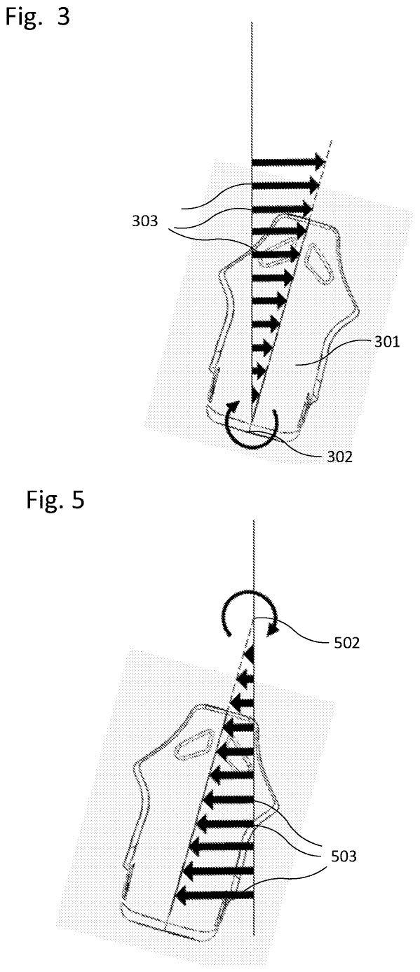

FIG. 3 illustrates the behaviour of a prior-art motion simulator where motion actuators control motion of the movable platform from below. The backrest 301 of a seat is illustrated from behind. A turning to the left using a steering wheel during driving of a simulated vehicle is responded to by the motion simulator with a rotation to the right of the movable platform, where the rotation is carried out around a point of rotation 302 being located the below the user being located in the seat of the motion simulator. The movable platform, and hence user, is rotated to the right as seen from behind, where the degree of acceleration will be higher and higher as the distance from the point of rotation increases. This is indicated by arrows 303, which also indicate the direction of rotation that the driver is subjected to, i.e. to the right in the figure, and hence in the complete opposite direction in relation to the situation in FIG. 2B, which illustrates the acceleration expected by the brain. Since the acceleration increases with the distance from the point of rotation 302, and hence towards the position of the head of the user, and the body motion sensors of the inner ears, the head of the user will be subjected to a high acceleration directed in the wrong direction in relation to what is expected by the brain for the particular type of vehicle motion, with possible motion sickness and/or blurry eyesight as result.

According to the inventive solution of FIG. 1, on the other hand, the situation is completely different. This is illustrated in FIG. 4, which shows the system of FIG. 1 from behind, and where the point of rotation of the movable platform 110 is defined by the articulated joint 119. In the illustration, the upper motion actuator 120 has been positioned towards the right as seen from behind, e.g. by displacing the movable platform to the right, so that the platform 110 can be rotated about the point of rotation 119 through the control of the lower motion actuator 150 and/or 130 by causing a motion to the left in the figure by the motion member, respectively, of the motion actuators 150 and/or 130. Hence, instead of carrying out the rotation of about a point being located below the user, the rotation can, instead be carried out through the use of a point of rotation located above the head of the user. One or more of the lower motion actuators 130, 140, 150 may also simultaneously be utilised to provide a rotation of the movable platform about an axis of rotation in the Z direction of FIG. 1 to further enhance the feeling of turning left.

This provides for a motion with much higher fidelity, such as when simulating a turning to the left or right. This is also illustrated in FIG. 5, which shows the acceleration forces in a manner similar to FIG. 3 but where, instead, the rotation is carried out about a point of rotation 502 and where the amplitude of the acceleration that the user of the motion simulator is subjected to is illustrated by arrows 503. As can be seen from FIG. 5 when comparing to FIGS. 2A and 2B, the acceleration is now going in the same, and hence correct, direction as would be the case when driving an actual vehicle. The magnitude of the acceleration increases with the distance from the point of rotation 502, and is highest at the general location of the hips of the user which also provides for a good haptic feedback to the user.

The present invention provides for a solution that is capable of accurately mimicking accelerations in a manner that provides for a cost effective and also space efficient solution. When the user of the motion simulator is subjected to the correct kind of accelerations this also avoids problems not only with regard to e.g. motion sickness but also improves the availability in controlling the vehicle because of the accurate accelerations that the user is subjected to. In comparison to prior art solutions a desired motion may be carried out using less actuators, and/or providing a better stroke length of the motions to be carried out. For example, hexapod solutions are capable of providing a point of rotation above a head of a user, through combined translation and rotation of the movable platform. Hexapods, however, are very sensitive to such movements and reaches the end of the possible stroke length of the movement actuators quickly.

The upper motion actuator according to the invention also provides for various other motions of the movable platform. For example, the invention also allows that the movable platform can be subjected to a translational motion, e.g., in the Y direction when simulating a left turn as above by displacing the upper motion actuator to the left in parallel to the lower motion actuators, or at a lower phase to allow simultaneous rotation about the X axis and/or Z axis, when carrying out the desired motion. This may provide for even more accurate accelerations.

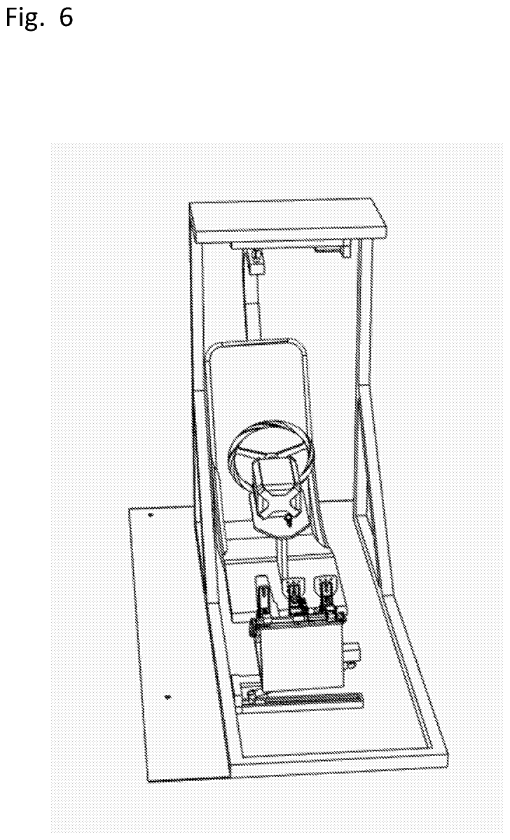

According to the illustrated example, the motion actuators are utilised to provide yaw, pitch and roll of the movable platform. In addition, one or more of these motion actuators are used together with upper motion actuator to obtain a translational movement in the Y direction. This is illustrated in FIG. 6, where the movable platform is displaced to a position to the right in the direction of driving using a translational motion in the Y direction. According to embodiments of the invention the upper motion actuator is arranged in the X direction instead, thereby providing for a translational motion in the X direction instead of the Y direction. As was previously explained, that which has been described above with regard to turning motions is equally applicable for braking and acceleration, where similar situations may arise with motion simulators that are not capable of providing an upper point of rotation, and where an upper motion actuator acting in the X direction may facilitate braking and acceleration simulations.

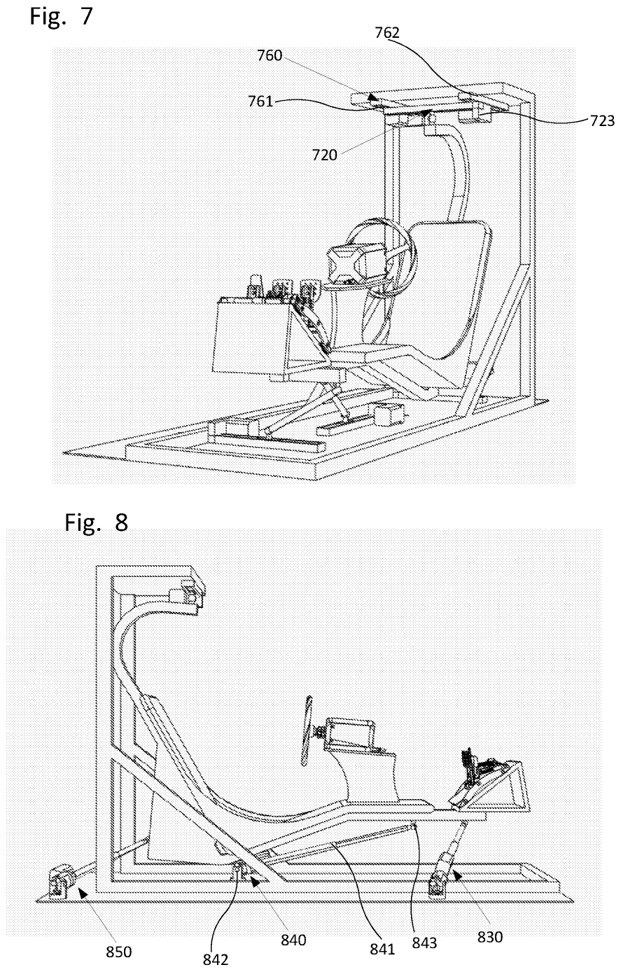

According to the embodiment illustrated in FIG. 1, a single upper motion actuator is utilized. According to embodiments of the invention, in addition, a further motion actuator is utilized to provide for translational movement also in the X (or Y) direction. This is illustrated in FIG. 7, which illustrates an embodiment being similar to the embodiment of FIG. 1, however with the difference that the upper motion actuator 720 that operates in the Y direction under the control of actuator motor 723 is attached to a further motion actuator 760 comprising two tracks 761, 762 along which the first motion actuator 720 runs in the X direction. The solution according to FIG. 7, consequently, provides for a further degree of freedom when displacing the movable platform. The additional movement actuator of FIG. 7 is controlled by actuator motor 763, which controls the motion of motion actuator 720 along the tracks 761 and 762. According to the solution of FIG. 7, translational displacement of the movable platform in both X and Y direction is possible through the use of appropriate control of the upper and lower motion actuators. According to embodiments of the invention, a third upper motion actuator is also utilized, which in addition may provide translational movements in the Z direction.

According to embodiments of the invention, the motion simulator comprises upper motion actuators operating in the X direction and Z direction, or Y direction and Z direction instead.

With further regard to the use of a single motion actuator acting in one direction as in FIG. 7, such as the Y direction, simulation of acceleration in the X direction may be improved through the use of a point of rotation being located at a first height above the seat so as to be located at least a predetermined distance above a head of a user when situated in the seat. The use of such a high point of rotation allows body accelerations in vehicle braking and acceleration simulations that go in the right direction, i.e., backwards for braking actions, and forward for acceleration actions, as discussed above, also when no actuator act in the particular direction, although to a lesser extent. Hence, the upper actuator may be combined with a high suspension point to allow for accurate accelerations in further directions. For example, a rotation about the Y axis going through the joint 119 of FIG. 1, e.g., backwards to simulate a braking action will result in an acceleration of the user in the same direction as the rotations experienced when driving an actual vehicle, where simultaneously the movable platform is tilted in a manner similar to an actual braking action.

As was mentioned above, the various motion actuators may be of different kinds where a particular kind is illustrated in FIG. 1, and another example is illustrated by the combination of the two upper motion actuators in FIG. 7. A further example of motion actuators is illustrated in FIG. 8 by motion actuators 830, 840, 850. According to the illustrated example, the motion actuators 830, 840 and 850 do not comprise a linear track. Instead, the motion actuators (exemplified by motion actuator 840) comprise an extendable rod 841, such as a cylinder provided with a movable piston therein or other suitable means which is attached to the base through a first articulated joint 842 and where the other end of the extendable rod 841 is attached to the movable platform through a further articulated joint 843. According to the example of FIG. 8 displacement of the movable platform is instead accomplished by extending and retracting the rods of the motion actuators 830, 840, 850 as well as through control of one or more upper motion actuators. Similar to the above, the actuators may be attached to the base and the movable platform at any suitable location and hence need not be arranged as is illustrated in the figure. It is also to be understood that various other different kinds of motion actuators may be utilized within the scope of the invention.

In sum, it is provided a motion actuator that provides for a solution that subjects the user to accurate accelerations in which is capable of providing stroke lengths that exceeds other devices of similar size. Furthermore, since the number of motion actuators being utilized correspond to the degree of freedom of displacement of the movable platform, the requirements regarding computational performance may be reduced since overdetermined calculations need not be performed which otherwise is to case when there are more motion actuators than degrees of freedom of motion of the movable platform. It is further to be understood that the calculations may be carried out using any suitable computational means, such as a computer being suitably located on the motion simulator. According to embodiments, the motion simulator is connected to an external computer using suitable means of connection, where the external computer may run suitable software for controlling the motion simulator.

It is to be understood that the illustrated motion simulator may comprise various cables or other connection means for interconnecting and powering the various components of the motion simulator as is known for motion simulators per se.

The invention is not limited to the above-described embodiments. Instead, the invention relates to, and encompasses all different embodiments being included within the scope of the claims.

1-19. (canceled)

20. A motion simulator, comprising:
a base;
a movable platform being movable in relation to the base, having a seat and driver manoeuvrable means for, in use, receiving driving commands from a user situated in the seat, the driving commands being configured to, in use, control motion of a simulated vehicle;
at least one first motion applying means comprising at least one motion actuator connecting the movable platform to the base, the at least one first motion applying means being configured to generate a displacement of the movable platform in relation to the base;
a support mechanism comprising an upper suspension configured to suspend the movable platform from above;
at least one second motion applying means comprising at least one motion actuator connecting the upper suspension to the support mechanism, the at least one second motion applying means being configured to generate a displacement of the movable platform in relation to the base;
wherein the movable platform has a longitudinal direction, representing a general longitudinal direction of a simulated vehicle, and a lateral direction, wherein the at least one second motion applying means is configured to generate a displacement of the upper suspension in at least one of:
a longitudinal direction, a transversal direction, a vertical direction, in relation to the base.

21. The motion simulator according to claim 20, wherein the motion simulator is configured to cause a motion of the movable platform utilising the at least one second motion actuator that act on the movable platform from above, and also the at least one first motion actuator that act on the movable platform from below the movable platform.

22. The motion simulator according to claim 20, wherein the at least one first motion applying means and the at least one second motion applying means are configured to be simultaneously controlled to displace the movable platform in response to received driving commands.

23. The motion simulator according to claim 20, wherein the at least one first motion applying means and the at least one second motion applying means are configured such that simultaneous activation allow translational motion of the movable platform in at least one non-vertical direction.

24. The motion simulator according to claim 20, wherein the at least one first motion applying means is attached to the base at a position below the movable platform.

25. The motion simulator according to claim 20, wherein the at least one first motion applying means comprises at least three motion actuators, each motion actuator attaching the movable platform to different locations of the base, and being configured to displace the movable platform in relation to the base.

26. The motion simulator according to claim 25, wherein at least two of the motion actuators are attached to the base at a position below the movable platform.

27. The motion simulator according to claim 25, wherein the motion actuators are attached to different positions on the movable platform, and different positions on the base.

28. The motion simulator according to claim 25, wherein the at least one first motion applying means comprises three motion actuators being arranged in a tripod configuration.

29. The motion simulator according to claim 20, wherein the at least one second motion applying means comprises at least two motion actuators, the motion actuators being configured to generate a displacement of the upper suspension in different directions.

30. The motion simulator according to claim 29, wherein the at least one first motion applying means and the at least one second motion applying means are configured to, through motion of one or more motion actuators of the first and second motion applying means, displace the movable platform in relation to the base such that the movable platform:
is subjected to an acceleration constituting one of, or a combination of, a rotation about a vertical axis, a rotation about an axis parallel to a longitudinal axis, a rotation about an axis parallel to a transversal axis, a translational motion along the longitudinal axis, a translational motion along the transversal axis, a translational motion along the vertical axis.

31. The motion simulator according to claim 20, wherein motion actuators of the at least one first motion applying means and the at least one second motion applying means are configured to displace the movable platform in relation to the base by means of a linear motion along the base and/or a linear extension/retraction of the motion actuator.

32. The motion simulator according to claim 31, wherein one or more of the motion actuators are attached to the movable platform by means of a first articulated joint, and to the base or upper suspension by means of a second articulated joint, the motion actuator being configured to displace the movable platform by means of a linear extension and/or retraction of the one or more motion actuators.

33. The motion simulator according to claim 31, wherein one or more of the motion actuators comprise a track rigidly attached to the base and/or upper suspension, and an elongated member, a first end of which being displaceable along the track, and the second end of the elongated member being attached to the movable platform, the motion actuator being configured to displace the movable platform by means of a displacement along the track.

34. The motion simulator according to claim 20, wherein the support mechanism is configured according to one in the group of:
the support mechanism is attached to, or form part of, the base; and
the support mechanism is configured such that the upper suspension suspends the movable platform at a point of rotation being located at a first height above the seat so as to be located at least a predetermined distance above a head of a user when situated in the seat.
